(19) United States
(12) Patent Application Publication
(10) Pub. No.: US 2008/0310287 A1
(43) Pub. Date: Dec. 18, 2008

(54) DEFORMABLE MIRROR APPARATUS, OPTICAL PICKUP AND OPTICAL DRIVE APPARATUS

(75) Inventors: Sunao AOKI, Kanagawa (JP); Masahiro Yamada, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/124,009

(22) Filed: May 20, 2008

(30) Foreign Application Priority Data
Jun. 18, 2007 (JP) 2007-160462

(51) Int. Cl. G11B 7/00; G02B 5/08

(52) U.S. Cl. 369/112.29; 359/846

(57) ABSTRACT

A deformable mirror apparatus is disclosed. The apparatus includes a flexible member having a mirror on a surface and having a part having a different section form to form a convex on the opposite surface of the mirror such that a predetermined strength distribution is imparted to the flexible member; a base substrate; a strength securing member provided between the base substrate and the flexible member to support the flexible member from the base substrate side; and a driving section that deforms the form of the mirror by applying driving force to the opposite surface of the mirror of the flexible member.

### CROSS REFERENCES TO RELATED APPLICATIONS

The present invention contains subject matter related to Japanese Patent Application JP 2007-160462 filed in the Japanese Patent Office on Jun. 18, 2007, the entire contents of which being incorporated herein by reference.

### BACKGROUND OF THE INVENTION

1. Field of the Invention

The present invention relates to a deformable mirror apparatus the mirror of which can be deformed and an optical pickup including the deformable mirror apparatus. The present invention further relates to an optical drive apparatus that writes to or read from an optical recording medium.

2. Description of the Related Art

In an optical drive apparatus that writes to or read from an optical disk recording medium, for example, laser light is focused on a recording layer of the optical disk recording medium through an objective lens to read or write a signal thereon.

It is known that, in a case where laser light is irradiated through an objective lens, the spherical aberration occurs due to the difference in thickness of the cover layer (cover thickness) from a recording surface to the recording layer of the optical disk recording medium. In a case where the optical system is designed to minimize the spherical aberration with the assumed value of the cover thickness on a subject optical recording medium, the spherical aberration may occur if the cover thickness is different from the assumed value.

For that reason, the spherical aberration occurs if the cover thickness of an optical disk recording medium is uneven.

In recent years, some optical disk recording media may have multiple recording layers in order to achieve higher recording densities. The spherical aberration may occur in writing to or reading from a recording layer excluding a reference recording layer since the cover thicknesses to the recording layers are apparently differentiated in an optical disk recording medium having multiple recording layers as described above.

The occurrence of a spherical aberration may deteriorate the performance of image forming and further deteriorate signal writing/reading performance. Therefore, some means for correcting the spherical aberration may be desired.

In the past, various technologies have been proposed (refer to JP-A-5-151591 (Patent Document 1), JP-A-9-152505 (Patent Document 2) and JP-A-2006-155850 (Patent Document 3)) that deform the surface form of a mirror included in the optical disk in order to correct a spherical aberration caused by the differences in cover thickness in an optical recording medium as described above.

Among them, the invention disclosed in Patent Document 3 has been proposed by the present inventors. Specifically, there is provided a deformable mirror apparatus “including a mirror on a surface, a flexible member having parts where the states regarding deformed forms are differentiated by circular or oval forms having the identical center, and driving means for applying driving force to the flexible member and deforming the form of the mirror”.

With the configuration with the flexible members disclosed in Patent Document 3, the mirror can be deformed to a deformed form according to the application of a predetermined even amount of driving force to the flexible member. Thus, the mirror can be deformed to a desired form, without adopting a complicated configuration having multiple piezoelectric actuators to which partially different driving forces are applied as in the Patent Document 1. In other words, this can prevent the increase in size of the circuit of the deformable mirror apparatus, which can reduce the circuit manufacturing costs.

According to the invention disclosed in Patent Document 3, the flexible member can obtain desired deformation forms in stepwise manner according to the levels of the applied driving force, which allows two or more kinds of deformation forms of the mirror. This can improve the point that it is difficult to support three or more recording layers as by the invention disclosed in Patent Document 2 and allows performing spherical aberration correction effectively on all of the recording layers in a case where there are two or more recording layers in addition to the recording layer, which is defined as a reference in designing the optical system.

### SUMMARY OF THE INVENTION

Here, it is assumed that the flatness of the flexible member is obtained at a state without the application of driving force (that is, an undeformed state) in obtaining a predetermined deformation form of the mirror for aberration correction by the application of driving force to the flexible member. This is because a pattern of parts at different states of the deformation form, which are formed in the flexible member for obtaining the predetermined deformation form, is defined by assuming that the mirror without deformation is flat.

The factor that is responsible for the deterioration of the flatness of the flexible member may be the precision of the assembly of the mirror apparatus. In other words, if the mirror apparatus is assembled with precision to some extent, the occurrence of unnecessary stress can be suppressed, and the flatness of the mirror can be obtained.

However, even with the state that the flatness of the mirror of a mirror apparatus alone is obtained, the stress caused within the apparatus by the attachment of the assembled mirror apparatus to another apparatus such as an optical drive apparatus may disadvantageously deteriorate the flatness of the mirror.

For example, a deformable mirror apparatus 70 shown in FIG. 19 in Patent Document 3 has a base 65 and a flexible member 2 bonded with the respective outer edges in contact with each other. In this configuration, the stress caused by the attachment of the mirror apparatus to another apparatus may be propagated to the flexible member 2 side through the outer edges. Thus, the mirror is deformed, which deteriorates the flatness.

The deterioration of the flatness of the mirror may cause asymmetry in the deformation form when the mirror is driven and may prevent the mirror from obtaining a predetermined deformation form according to the application of a predetermined amount of driving force. As a result, the precision of the aberration correction is reduced.

Here, in order to prevent the deterioration of the flatness upon attachment as described above in the configuration with the bonding of the outer edges shown in FIG. 19, the thickness of the horizontal section of the outermost part (frame 2E) of the flexible member 2 may be increased to obtain the strength against the stress from the base 65 side.

However, increasing the width of the outermost part of the flexible member 2 may increase the size of the mirror apparatus.

Here, the range of a strength distribution pattern 2a in FIG. 19 is the part where the pattern for obtaining a predetermined deformation form is formed as a deformation form of the mirror when a coil is energized and pressure is applied to the flexible member 2. For that reason, when the thickness of the outermost part of the flexible member 2 is increased, the width is increased toward the outer edge by keeping the space where the strength distribution pattern 2a is formed. As a result, the size of the mirror apparatus may be increased.

Patent Document 3 discloses a deformable mirror apparatus 60 of a center bonding type in which the flexible member 2 and the base 61 are bonded through the respective centers, as shown in FIG. 16 in Patent Document 3. In this configuration, a driving coil 35 is wound about the outermost edge of the flexible member 2, and a magnet 34 is provided on an outer circumferential wall 61a at the outermost part of the base 61. Thus, the mirror can be deformed.

However, in this configuration, the outer circumferential wall 61a of the base 61 is formed at a position much outer than the outermost part of the flexible member 2 and at a position where the space for placing a magnet 34 and a space between the magnet 34 and the driving coil 35 are formed. As a result, the width of the base 61 is increased, which may promote the increase in size of the apparatus.

In order to prevent the increase in size as described above, the configuration might be possible in which the outer circumferential part than an inner circumferential wall 61b of the base 61 is omitted by winding the driving coil 35, which has been wound on the outer edge side of the outermost part of the flexible member 2, on the inner circumferential side and providing the magnet 34 on the inner circumferential wall 61b side of the base 61. However, although the configuration without the outer circumferential part than the inner circumferential wall 61b of the base 61 may be possible, this configuration exposes the outermost part of the flexible member 2 in the mirror apparatus 60, and the risk of damaging the flexible member 2 might be increased while the apparatus is being handled. For that reason, it is significantly difficult to handle the mirror apparatus to be attached to another apparatus, which causes a problem in practicality.

Accordingly, it is desirable to provide a deformable mirror apparatus in a configuration that can secure the strength for suppressing the deterioration of the flatness of the mirror due to the stress caused in the mirror apparatus when attached to another apparatus and can suppress the increase in size of the apparatus.

According to embodiments of the invention, there is provided a deformable mirror apparatus having the following configuration.

That is, a deformable mirror apparatus according to an embodiment of the invention includes a flexible member having a mirror on a surface and having a part having a different section form to form a convex on the opposite surface of the mirror such that a predetermined strength distribution is imparted to the flexible member, and a base substrate.

The deformable mirror apparatus further includes a strength securing member provided between the base substrate and the flexible member to support the flexible member from the base substrate side.

The deformable mirror apparatus further includes driving means for deforming the form of the mirror by applying driving force to the opposite surface of the mirror of the flexible member.

In this way, the deformable mirror apparatus according to the embodiment of the invention has the strength securing member between the base substrate and the flexible member. Thus, even in a case where stress is caused within the mirror apparatus when attached to another apparatus, the force based on the strength can be prevented effectively from being transmitted to the flexible member. As a result, the deterioration of the flatness of the mirror can be suppressed.

According to the embodiment of the invention as described above, the deterioration of the flatness of the mirror, which may be caused when the deformable mirror apparatus is attached to another apparatus in the past, can be suppressed. Then, the suppression of the deterioration of the flatness in this way can improve the precision for deforming the mirror, and the precision for aberration correction can be improved accordingly.

The strength securing member, which is provided separately, is responsible for the function of securing the strength, instead of the flexible member side, according to the embodiment of the invention. Thus, the horizontal section thickness of the strength securing member can be increased not in the outer circumferential direction but in the inner circumferential direction of the apparatus. As a result, the increase in size of the deformable mirror apparatus for securing the strength can be effectively suppressed.

The separately provided strength securing member that is responsible for the strength securing function can eliminate the necessity for the increase in thickness in the vertical direction of the outermost part of the flexible member. Thus, the etching depth in etching processing can be reduced for forming the outermost part and the section formation pattern (strength distribution pattern) of the flexible member. Therefore, the time for the etching step can be reduced, and the manufacturing efficiency can be improved, which can reduce the costs for manufacturing the apparatus.

Furthermore, the reduction of the etching depth in processing the flexible member can improve the precision of the dimension of the step form of the section formation pattern accordingly.

### BRIEF DESCRIPTION OF THE DRAWINGS

FIG. 1 is a block diagram showing the internal configuration of an optical drive apparatus including a deformable mirror apparatus according to an embodiment of the invention;

FIG. 2 is a diagram showing the internal configuration of an optical pickup including an optical drive apparatus according to the embodiment;

FIG. 3 is a section view showing the configuration (without deformation) of the deformable mirror apparatus according to the embodiment;

FIGS. 4A and 4B are diagrams showing the configuration of a flexible member included in the deformable mirror apparatus according to the embodiment;

FIG. 5 is a diagram for explaining a spot form of laser light on the mirror of the deformable mirror apparatus according to the embodiment;

FIG. 6 is a diagram for explaining an example of the method of manufacturing the deformable mirror apparatus according to the embodiment;

FIG. 7 is a section view showing the configuration (deformed to a concave) of the deformable mirror apparatus according to the embodiment;

FIG. 8 is a section view showing the configuration (deformed to a convex) of the deformable mirror apparatus according to the embodiment; and

FIGS. 9A and 9B are diagrams for explaining the fact that the increases in size of the apparatus can be suppressed by the configuration of the deformable mirror apparatus according to the embodiment.

### DESCRIPTION OF THE PREFERRED EMBODIMENTS

Embodiments of the invention will be described.

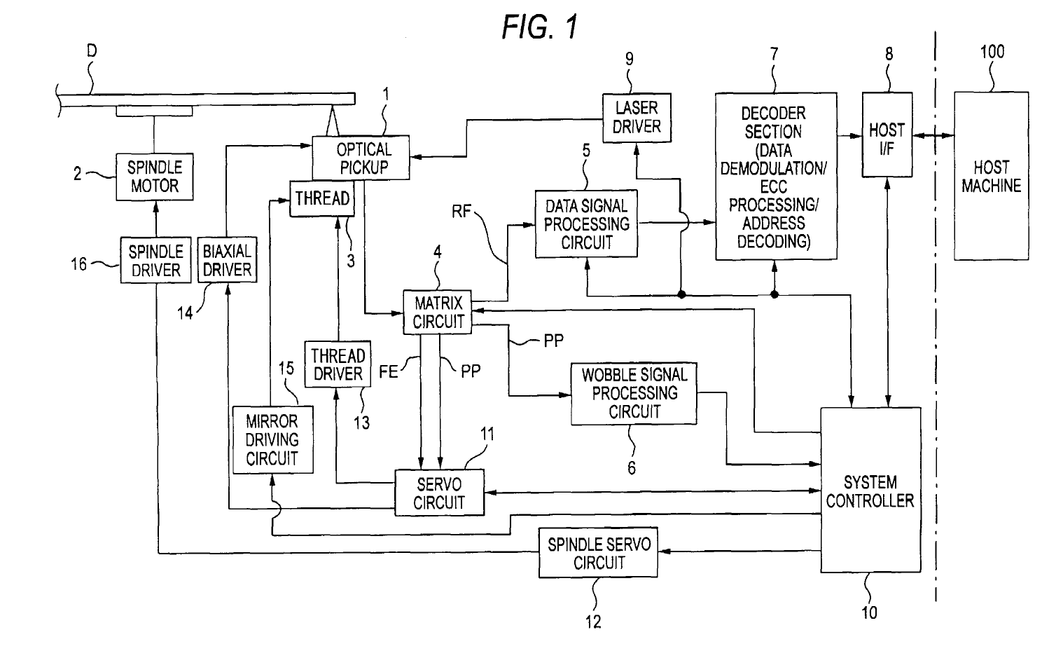

First of all, with reference to FIG. 1, the configuration of a disk drive apparatus will be described which includes an optical pickup having a deformable mirror apparatus according to an embodiment of the invention.

The disk drive apparatus may be a read-only apparatus that can read data only. The disk drive apparatus can read not only an optical disk D, which is a read-only ROM disk storing data by a combination of pits and lands, but also a write-once or rewritable optical disk D, which is one of writable disks.

First of all, referring to FIG. 1, the optical disk D is a multi-layered disk having multiple recording layers. According to this embodiment, the optical disk D is assumed as a high recording density disk such as BD (“BLU-RAY DISC (Registered Trademark)”). For example, writing/reading is performed thereon with NA=0.85 of an objective lens 26, which will be described later, and a laser wavelength of 405 nm, for example.

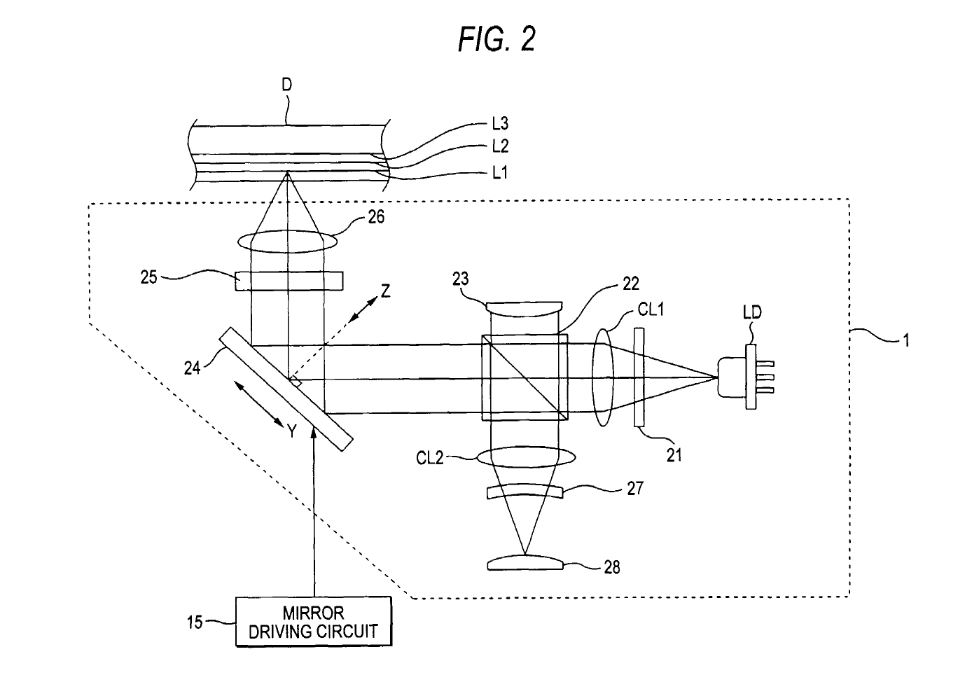

In this case, the optical disk D has three recording layers as shown in the partial section in the next FIG. 2. More specifically, a first recording layer L1, a second recording layer L2 and a third recording layer L3 are provided in order from the closest side to the surface (recording surface) to which laser light is irradiated. The space from the recording surface to the first recording layer L1 is about 0.075 mm. In other words, the cover thickness to the first recording layer L1 is 0.075 mm. In this case, the space between the recording layers is about 25 μm, and the cover thicknesses of the second recording layer L2 and the third recording layer L3 are 0.100 mm and 0.125 mm, respectively.

In FIG. 1, the optical disk D installed in the disk drive apparatus is driven to rotate at a constant linear velocity by a spindle motor 2 with the center hole attached to the turn table.

In reading, information written on tracks of the rotationally driven optical disk D with pits or marks is read out by an optical pickup (optical head) 1.

Physical information of the disk, for example, as management information for read only is recorded on the optical disk D with emboss pits or wobbling grooves and is read out also by the optical pickup 1. ADIP information embedded as a wobbling of a groove track may be recorded on the writable optical disk D and can be read out by the optical pickup 1.

The optical pickup 1 internally includes a laser diode LD, which is a laser light source, a photodetector 28 for detecting reflected light and the objective lens 26, which is the output end of laser light, and has an optical system that irradiates laser light to the disk recording surface through the objective lens 26 and guides the reflected light to the photodetector.

The internal configuration of the optical pickup 1 will be described later.

Within the optical pickup 1, the objective lens 26 is held movably in the tracking direction and the focus direction by a biaxial mechanism (not shown).

The entire optical pickup 1 is movable in the disk radius direction by a thread mechanism 3.

The laser diode LD in the optical pickup 1 is driven to emit laser light by a drive signal (drive current) from a laser driver 9.

The reflected light information from the optical disk D is detected by the photodetector 28, is converted to an electric signal according to the amount of received light and is supplied to a matrix circuit 4.

The matrix circuit 4 includes a current-voltage converting circuit and a matrix operation/amplifying circuit for output current from multiple photoreceptors functioning as a photodetector and generates a signal for matrix operation processing.

For example, the matrix circuit 4 may generate an RF signal (read data signal) corresponding to read data, a focus error signal FE for servo control and a tracking error signal TE.

The matrix circuit 4 may further generate a signal regarding a wobbling of a groove, that is, a push-pull signal PP as a signal detecting a wobbling.

The read data signal (FR signal), the focus error signal FE and the tracking error signal TE and the push-pull signal PP output from the matrix circuit 4 are supplied to a data signal processing circuit 5, a servo circuit 11 and a wobble signal processing circuit 6, respectively.

The data signal processing circuit 5 performs binarization processing on a read data signal. The data signal processing circuit 5 further generates a read clock by performing PLL processing. The data signal processing circuit 5 may further perform processing of detecting a synchronization signal from a binary data string after the binarization processing.

The binary data string obtained by the binarization processing in the data signal processing circuit 5 is supplied to a decoder section 7 in the subsequent stage. The generated read clock is supplied to an operational clock for each component, not shown. The detected synchronization signal is supplied to the decoder section 7.

The decoder section 7 performs demodulation processing on the binary data string. That is, the decoder section 7 performs demodulation processing such as demodulation, deinterleaving, ECC decoding and address decoding on read data.

In reading, the decoder section 7 performs demodulation processing on the binary data string, which is decoded by the data signal processing circuit 5, and the binary data string in timing indicated by the demodulation timing based on the synchronization signal and obtained read data. The data, which is decoded to read data by the decoder section 7, is transferred to a host interface 8 and is transferred to a host machine 100 based on the instruction by a system controller 10. The host machine 100 may be a computer machine or an AV (Audio-Visual) system machine.

The decoded address data is supplied to the system controller 10.

In a case where the optical disk D is a writable disk, the optical disk D records management information and/or ADIP information for physical information of the disk by a wobbling groove.

The wobble signal processing circuit 6 detects the information recorded by a wobbling groove of the optical disk D in this way from the push-pull signal PP from the matrix circuit 4 based on the instruction from the system controller 10 and supplies the detected information to the system controller 10.

The servo circuit 11 generates a servo signal such as for focus, tracking and thread from the focus error signal FE and the tracking error signal TE from the matrix circuit 4 and causes to perform a servo operation.

In other words, the servo circuit 11 generates the focus servo signal or the tracking servo signal according to a focus error signal FE or a tracking error signal TE and supplies the signal as the drive signal (focus drive signal FD or tracking drive signal TD) for a biaxial driver 14. Thus, the focus coil and tracking coil of the biaxial mechanism within the optical pickup 1 are controlled to drive by the drive signal according to the servo signal. Therefore, a tracking servo loop and a focus servo loop are formed by the optical pickup 1, the matrix circuit 4, the servo circuit 11, the biaxial driver 14 and the biaxial mechanism.

The servo circuit 11 turns off the tracking servo loop according to the track jump instruction from the system controller 10 and outputs a jump pulse to cause a track jump operation to perform.

The servo circuit 11 drives the thread mechanism 3 by a thread driver 13 based on the thread error signal obtained as a low frequency component of a tracking error signal TE or the access execution control from the system controller 10. The thread mechanism 3 has a mechanism including a main shaft holding the optical pickup 1, a thread motor and a transmission gear, not shown. The thread motor is driven based on the thread drive signal to perform a slide movement of the optical pickup 1.

The servo circuit 11 is configured to allow setting of a focus bias. That is, the focus bias based on the instruction from the system controller 10 can be added to the focus servo loop.

The spindle servo circuit 12 controls the spindle motor 2 to perform CLV rotation.

The spindle servo circuit 12 obtains a read clock, which is generated by the data signal processing circuit 5, as rotation velocity information of the current spindle motor 2, compares it with predetermined CLV reference speed information and thus generates a spindle error signal.

In a case where the optical disk D is a writable disk, clocks generated by PLL processing on a wobble signal can be obtained as the current rotational velocity information of the spindle motor 2. Therefore, a spindle error signal can be generated by comparing it with predetermined CLV reference speed information.

Then, the spindle servo circuit 12 outputs the spindle drive signal generated according to the spindle error signal and causes the spindle motor 2 to perform CLV rotation through the spindle driver 16.

The spindle servo circuit 12 generates a spindle drive signal according to the spindle kick/brake control signal from the system controller 10 and causes the spindle motor 2 to perform an operation such as start, stop, acceleration and deceleration.

The disk drive apparatus according to this embodiment includes a mirror driving circuit 15 that drives the deformable mirror apparatus 24 as will be described later, which is provided within the optical pickup 1. The mirror driving circuit 15 supplies a drive signal to the deformable mirror apparatus 24 based on the instruction from the system controller 10 to control to drive the deformable mirror apparatus 24.

The servo-related and read-related operations as described above are controlled by the system controller 10 including a microcomputer.

The system controller 10 performs processing according to the command from the host machine 100 through the host interface 8.

For example, in a case where a read command is supplied from the host machine 100 for requesting the transfer of certain data recorded on the optical disk D, the system controller 10 controls the seek operation for the instructed address first as a target. In other words, the servo circuit 11 is instructed to perform an access operation by the optical pickup 1 by handling the address specified by the seek command as a target.

After that, operation control is performed for transferring the data in the instructed data duration to the host machine 100. In other words, reading processing in the data signal processing circuit 5 and the decoder section 7 are performed on the signal (read data signal) read out from the optical disk D, and the requested data is transferred.

According to this embodiment, the system controller 10 instructs the mirror driving circuit 15 to control the deformation state of the mirror. The control over the deformation of the mirror as described above will be described later.

Having described the disk drive apparatus connecting to the host machine 100 in the example in FIG. 1, the optical drive apparatus according to the embodiment of the invention may not connect to another apparatus. In that case, it is different from that in FIG. 1 in further provided operation and display units and/or the configuration of the interface part for data input/output. In other words, it is important to write or read according to a user operation and to have a terminal unit for input/output of data.

Apparently, the configuration examples of the optical drive apparatus may vary more than those described above and may have a writable configuration. In other words, the drive apparatus of the embodiment of the invention may be a reader/writer or a write-only apparatus.

FIG. 2 schematically shows the internal configuration of the optical pickup 1 shown in FIG. 1. FIG. 2 mainly shows the configuration of the optical system as the internal configuration of the optical pickup 1. FIG. 2 further shows how laser light emitted from the optical pickup 1 is irradiated to the optical disk D and the mirror driving circuit 15 shown in FIG. 1.

As shown in FIG. 2, the optical pickup 1 internally includes the laser diode LD, a grating 21, a collimator lens CL1, a polarized beam splitter 22, a front monitor 23, the deformable mirror apparatus 24, a ¼ wave plate 25, the objective lens 26, a collimator lens CL2, a multi-lens 27 and the photodetector 28.

In the optical system within the optical pickup 1, laser light emitted from the laser diode LD enters to the polarized beam splitter 22 by linear polarization through the grating 21→the collimator lens CL1. A part of the laser light by linear polarization, which has entered to the polarized beam splitter 22, is reflected and is guided to the front monitor 23, which is provided for monitoring laser output.

The polarized beam splitter 22 allows a part of the laser light input by linear polarization to pass through in the manner as described above. The passing laser light is irradiated to the mirror of the deformable mirror apparatus 24 as shown in FIG. 2. In this case, the deformable mirror apparatus 24 is tilted with the angle of the mirror about the optical axis of incident laser light at 45 degrees. In addition, the optical pickup 1 is installed such that the optical axis of the incident laser light can agree with the center of the mirror. Thus, the incident laser light on the deformable mirror apparatus 24 is reflected by changing the optical axis by 90 degrees on the mirror.

Here, as shown in FIG. 2, the axial direction orthogonal to the mirror of the deformable mirror apparatus 24 is defined as the Z-axis direction.

The reflected light from the mirror of the deformable mirror apparatus 24 enters to the ¼ wave plate 25 by linear polarization, is converted to circular polarization, then is collected by the optical lens 26 and is irradiated to the optical disk D.

In this case, the objective lens 26 is held displaceably in the direction that the objective lens 26 moves toward or away from the optical disk D by a biaxial mechanism, not shown, (focus direction) and in the direction of the radius of the optical disk D (tracking direction). The biaxial mechanism allows the collecting position (focusing position) for laser light through the objective lens 26 to agree selectively with one of the first recording layer L1, the second recording layer L2 and the third recording layer L3.

On the other hand, the reflected light (circular polarization) from the recording layer of the optical disk D is converted to linear polarization by entering again to the ¼ wave plate through the objective lens 26 and is then reflected by the mirror of the deformable mirror apparatus 24 as shown in FIG. 2 and enters to the polarized beam splitter 22. The polarized beam splitter 22 guides a part of the reflected light from the optical disk D to which the light has entered toward the collimator lens CL 2.

The reflected light through the collimator lens CL2 enters to the photodetector 28 through the multi-lens 27. As described above, the photodetector 28 converts the reflected light to an electric signal, and it is supplied to the matrix circuit 4 shown in FIG. 1.

Here, it is assumed, for example, in the following description that the second recording layer L2 of the optical disk D is defined as a reference recording layer for which the spherical aberration correction is not necessary. In other words, the optical system in this case is designed and adjusted such that the spherical aberration can be zero when the second recording layer L2 of the optical disk D is focused (for eliminating the necessity for the spherical aberration correction) at a state where the form of the mirror of the deformable mirror apparatus 24 is not deformed.

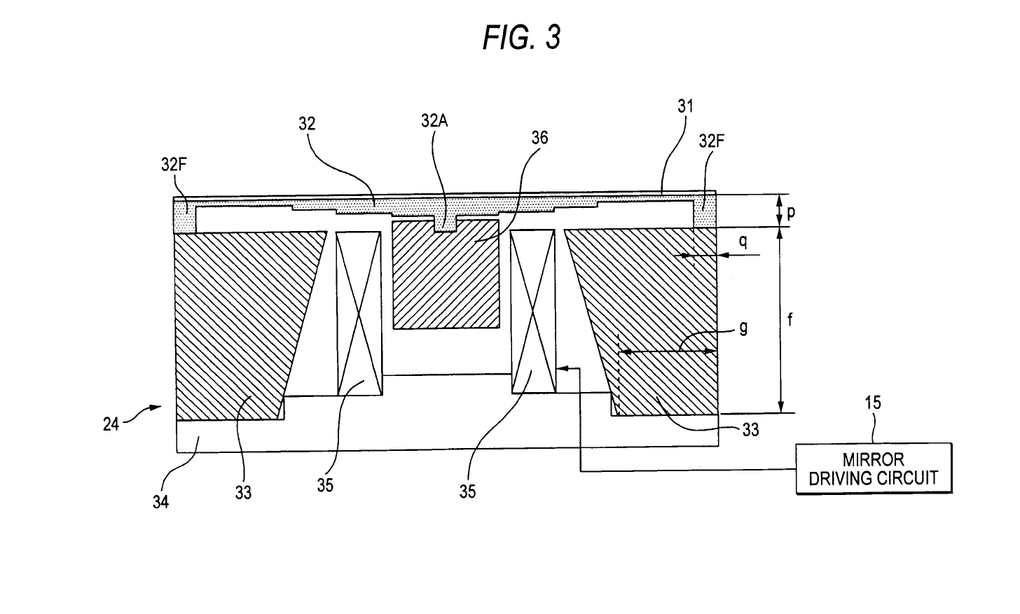

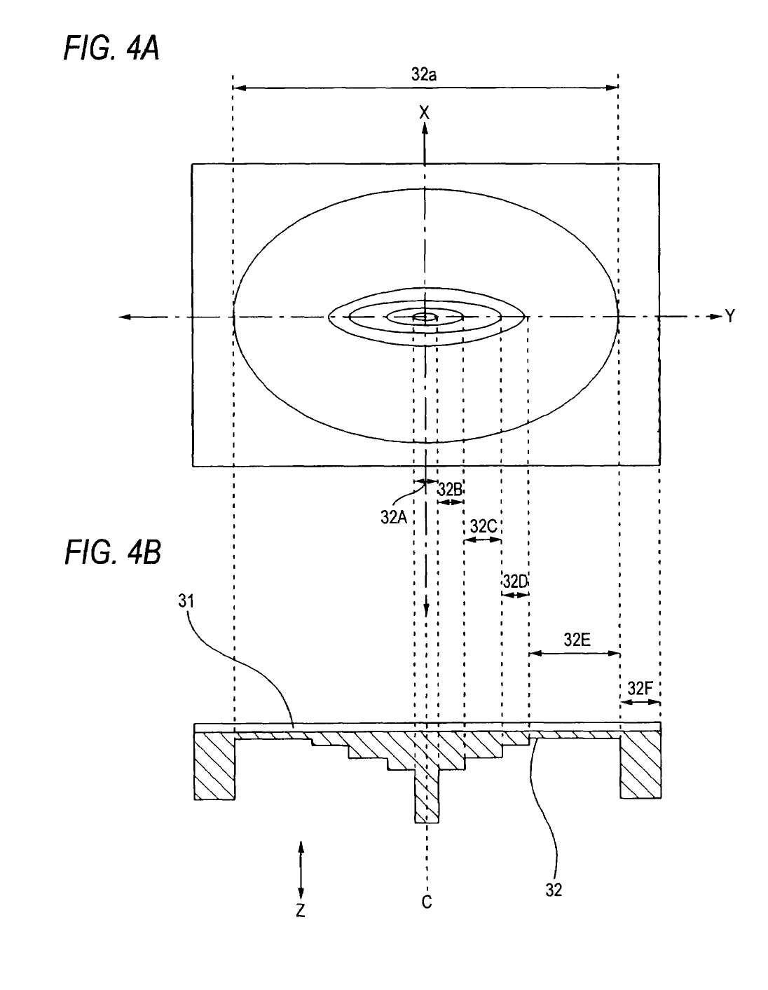

Next, with reference to FIGS. 3 and 4A and 4B, the internal configuration of the deformable mirror apparatus 24 will be described.

FIG. 3 shows a section view of the deformable mirror apparatus 24, and FIGS. 4A and 4B show the structure of a flexible member 32 having the deformable mirror apparatus 24. FIG. 4A shows the structure from the viewpoint in the Z-axis direction shown in FIG. 2, and FIG. 4B shows a section structure.

FIG. 3 further shows the mirror driving circuit 15 along with the deformable mirror apparatus 24.

First of all, as shown in FIG. 3, the deformable mirror apparatus 24 includes a flexible member 32, a reflective film 31 on the surface, a magnet 36, a base substrate 34, a driving coil 35 and a strength securing member 33. The magnet 36 is fixed to the flexible member 32 on the opposite surface of the mirror having the reflective film 31. The driving coil 35 is fixed to the base substrate 34. The strength securing member 33 is provided between the flexible member 32 and the base substrate 34.

First of all, the flexible member 32 may contain silicon and is flexible. The reflective film 31 is deposited to the surface to be the mirror of the flexible member 32.

Then, the flexible member 32 in this case has multiple eclipses 32A, 32B, 32C, 32D and 32E arranged concentrically on the center C on the back surface of the mirror in the manner shown in FIG. 4B. Among the multiple eclipses 32A to 32E, the eclipse 32A including the center C is the thickest in the z-axis direction, and the thickness in the Z-axis direction decreases in order from the next outer eclipse 32B, the next outer eclipse 32C, the next outer eclipse 32D and the next outer eclipse 32E. In other words, the section form of the flexible member 32 in this case has the thickness decreasing in a step form from the center C toward the outer circumference.

Then, the outer area than the area having the eclipse 32E has a rib-shaped frame 32F for securing the strength enough for preventing the deformation of the area when driving force is applied to the flexible member 32 in the Z-axis direction.

Here, in the flexible member 32, the range from the eclipse 32A to the eclipse 32E is a range that deforms as a deformed mirror. In other words, the formation pattern of the eclipse 32A to the eclipse 32E having different thicknesses can provide a predetermined deformation form of the mirror when driving force in the Z-axis direction is applied thereto.

In this way, forming a pattern with different section thicknesses can provide a desired strength distribution in the flexible member 32. In the meaning, the pattern with different section thicknesses is called strength distribution pattern.

In this case, the pattern with the eclipses 32A to 32E is called strength distribution pattern 32a.

The frame 32F having the strength enough for preventing the deformation against the application of driving force as described above is provided on the outer circumference of the area from the eclipse 32A to the eclipse 32E, which is a deformable range. Keeping the strength of the outermost part of the flexible member 32, which functions as the frame 32F, without any deformation against the application of driving force allows easy adjustment of the deformation form of the adjustable part from the eclipse 32A to the eclipse 32E to a more ideal deformation form accordingly. In other words, the deformation form of the mirror can be brought closely to an ideal form with higher precision, compared with the case where the outermost part of the flexible member 32 is deformed.

In this case, the strength distribution pattern 32a defined for obtaining a predetermined deformation form for aberration correction as the form of the mirror has an oval form in order to reflect incident light by 90 degrees by the mirror of the deformable mirror apparatus 24, which is provided as a 45-degree mirror, as shown in FIG. 2.

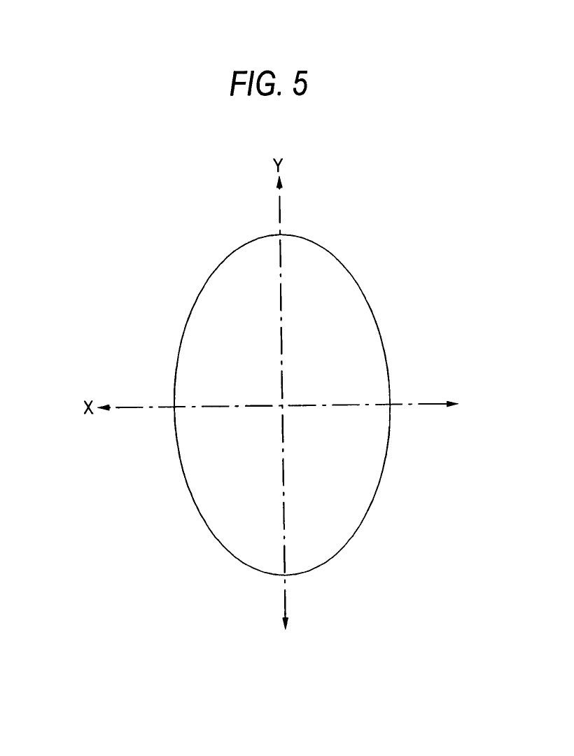

In other words, in a case where the deformable mirror apparatus 24 is provided as a 45-degree mirror, the irradiation spot for laser light on the mirror has an oval form as shown in the next FIG. 5. More specifically, the eclipse has the ratio of the diameter in the X-axis direction to the diameter in the Y-axis direction in FIG. 5 is about X:Y=1:√2 where the longitudinal direction of the spot is the Y-axis direction and the direction orthogonal thereto is the X-axis direction when the mirror is viewed from the Z-axis direction in the previous FIG. 2.

Since the spot form of the laser light on the mirror is an oval form, the strength distribution pattern 32a also has an oval form for performing the spherical aberration correction well.

The eclipses arranged concentrically on the center C in the strength distribution pattern 32a can prevent the concentration of stress to a part of the flexible member 32 when driving force is applied thereto. Thus, the flexible member 32 can be effectively protected from a break or a fatigue failure.

Here, when certain driving force is applied for deforming the mirror, an internal stress occurs in the flexible member 32. If there is a point where the stress concentrates in the flexible member 32, the dimension of the flexible member 32 changes significantly in a case where the flexible member 32 is formed from a homogeneous and isotropic material.

For example, in a pattern having eclipses, which are not co-centered, the spaces there among may be decreased or increased in a specific direction. The part with a decreased space may be the part where stress may be easily concentrated more than other parts and is therefore the part where the dimension is changed significantly by the application of uniform driving force.

The presence of the part where stress concentrates may increase the possibility of excess of the permissible stress of the flexible member 32 in that part, which therefore increases the possibility of causing a fracture. The repetitive deformation of the flexible member may cause a fatigue failure in that part.

The patterning of the eclipses to have the identical center as in this embodiment uniforms the spaces of the pattern and can prevent the cause of the part where the stress concentrates on one part as described above. In other words, a fracture or a fatigue failure as described above can be prevented.

Referring back to FIG. 3, the cylindrical magnet 36 is fixed to the eclipse 32A at the center of the flexible member 32. The magnet 36 has a concave for fitting and positioning the eclipse 32A into the center, and the concave fitted into the eclipse 32A is firmly fixed by bonding, for example.

Then, the frame 32F at the outermost part of the flexible member 32 is fixed to the strength securing member 33 as shown in FIG. 3.

Pyrex glass (“PYREX” (Registered Trademark)) may be selected for the material of the strength securing member 33. That is, a material with higher rigidity than that of the flexible member 32 is selected. The strength securing member 33 has a prism-shaped external form having a tapered hole at the center therethrough. In the strength securing member 33, the outside dimension of the two surfaces having the tapered hole agrees with the outer circumferential dimension of the surface having the mirror of the flexible member 32. The frame 32F of the flexible member 32 is fixed on one of the two surfaces. In this case, the flexible member 32 and the strength securing member 33 are fixed such that the respective center axes can be coaxial. Thus, the frame 32F is fixed to the part around the hole in the strength securing member 33.

The base substrate 34 has a surface having an equal outside dimension to that of the surface having the mirror of the flexible member 32. The surface having the equal dimension has a groove on the outermost part for positioning and fixing the opposite surface of the surface of the strength securing member 33 to which the flexible member 32 is fixed. More specifically, the groove is a circular convex having a substantially equal diameter to the inside dimension of the tapered hole on the opposite surface of the surface of the strength securing member 33 to which the flexible member 32 is fixed. Then, by positioning and fixing the strength securing member 33 at the groove for the convex, the center of the base substrate 34 and the center of the strength securing member 33 can be placed coaxially.

Furthermore, the base substrate 34 has a circular positioning convex at the center into which the inner wall of the driving coil 35 is to be fitted. More specifically, the center of the convex is coaxial with the center of the base substrate 34, and the outside dimension is defined for accepting the inner wall of the driving coil 35. The driving coil 35 fitted and fixed into the base substrate 34 at the convex separates the outer surface of the magnet 36 and the inner surface of the driving coil 35 apart from each other by a uniform distance across the entire circumference and places the center of the magnet 36 and the center of the driving coil 35 coaxially.

The driving coil 35 connects to a supply line for driving signals from the mirror driving circuit 15, as shown in FIG. 3.

In a case according to this embodiment, the thickness (height) p in the vertical direction of the frame 32F of the flexible member 32 shown in FIG. 3 is equal to 0.3 mm. In this case, the thickness (height) in the vertical direction of the eclipse 32A at the center of the flexible member 32 is also equal to p.

The height f of the strength securing member 33, which is also the thickness (height) in the vertical direction, is defined to be equal to 1.7 mm. In other words, comparing with the numerical value of the p, the height of the strength securing member 33 in this case is defined to be longer than the height of the frame 32F of the flexible member 32.

The thickness (width) in the horizontal direction is defined as at least q<g where the width of the frame 32F is q and the width of the strength securing member 33 is g (which is the value of the narrower width since the hole of the strength securing member 33 in this case is tapered).

Here, the vertical direction refers to the direction orthogonal to the mirror. The horizontal direction refers to the direction orthogonal to the vertical direction and parallel to the mirror.

Apparently, the dimension of the tapered hole of the strength securing member 33 should be defined in advance to allow the space that can accept the insertion of the driving coil 35.

It is also important to define the thickness f in the vertical direction of the strength securing member 33 such that a sufficient clearance can be provided between the driving coil 35 and the flexible member 32 since the interference between the flexible member 32 and the driving coil 35 if any when the flexible member 32 is deformed prevents a predetermined deformation form of the mirror.

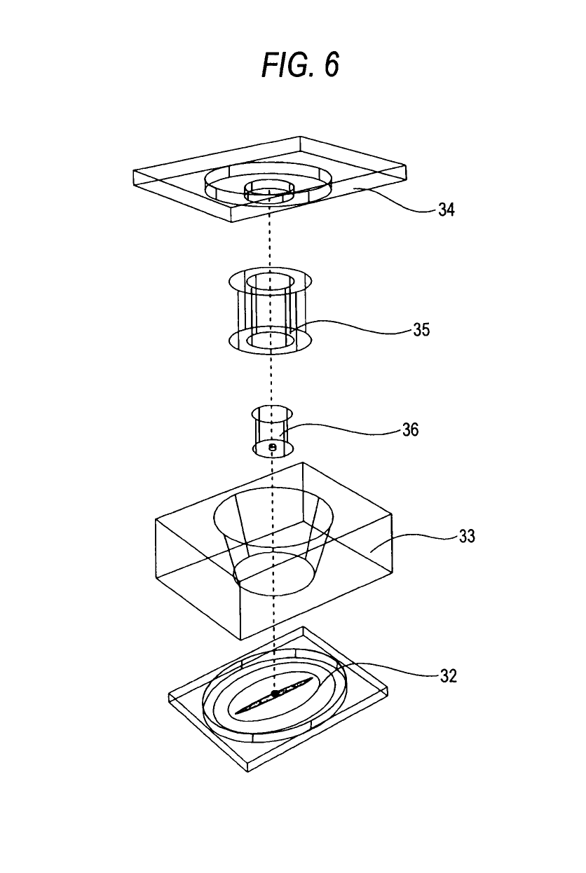

Here, referring to the next FIG. 6, an example of the method of manufacturing the deformable mirror apparatus 24 will be described. FIG. 6 shows a perspective view of an exploded perspective diagram of the deformable mirror apparatus 24.

First of all, silicon may be selected, for example, as the material of the flexible member 32 as described above. Etching processing using a semiconductor manufacturing process, for example, is performed on silicon in a plate form in thickness of p=0.3 mm. Thus, the section forms of the eclipses 32A to 32E and the frame 32F as shown in FIG. 4B can be obtained.

Notably, it is important for the silicon to have a thickness to some extent so as to obtain strength enough for handling in the manufacturing processing when the semiconductor manufacturing process is used. For example, a thickness of 0.3 mm or larger at least, for example, is important for processing a silicon wafer or a bulk silicon substrate.

According to this embodiment, the thicknesses P of the frame 32F and the eclipse 32A of the flexible member 32 are defined to be equal. By defining the thicknesses of the frame 32F and the eclipse 32A to be equal in this way, the thickness of the silicon before processing can be defined to be equal to the thickness of the frame 32F or the eclipse 32A at least. In other words, if the thicknesses of the eclipse 32A and the frame 32F are equal to p, the area subject to the etching processing may be the range from the eclipses 32B to 32E only.

In this case, the thickness of the silicon before processing is equal to 0.3 mm, which is the least thickness for obtaining the strength enough for the handling. Accordingly, the thickness p of each of the frame 32F and the eclipse 32A in this case is equal to 0.3 mm as described above.

The amount of etching in this case can be minimized because the area subject to the etching processing is only the range from the eclipses 32B to 32E as described above. In other words, if the thicknesses of the eclipse 32A and the frame 32F are not equal, it is important to perform the etching processing on the one whose thickness is to be reduced between the eclipse 32A and the frame 32F. Accordingly, the unnecessary etching processing is to be performed.

In this case, the use of an SOI substrate (Silicon-On-Insulator wafer) can reduce the thickness of the silicon part as a raw material of the flexible member 32 more than the 0.3 mm. In a case where an SOI substrate is used, the thickness of the silicon part can be defined to be equal to a minimum thickness for providing the strength distribution pattern 32a as shown in FIG. 4B, and the etching process can be thus minimized.

Referring to FIG. 6, in the flexible member 32 manufactured by forming by the etching above, the reflective film 31 containing aluminum, for example, is deposited by sputtering to the opposite surface of the surface having the section form of the strength distribution pattern 32a, whereby a mirror is formed. As described above, the magnet 36 is rigidly fixed to the eclipse 32A at the center by bonding, for example.

The strength securing member 33 is fixed to the opposite surface of the mirror with the center placed coaxially with the center of the flexible member 32. In this case, the flexible member 32 containing silicon and the strength securing member 33 containing Pyrex glass are fixed by anodic bonding.

Here, the combination of materials of the flexible member 32 and the strength securing member 33 may be defined in consideration of the linear expansion coefficients.

For example, it is important to heat the materials for bonding in a case where anodic bonding is performed. However, bonding the materials having completely different linear expansion coefficients may deform the flexible member 32 due to the difference in shrinkage of the materials returning to a room temperature after bonding. In other words, the flatness of the mirror may be deteriorated. In consideration of the fact, silicon and Pyrex glass are combined as described above which have relatively closer characteristics in linear expansion coefficients.

Alternatively, adopting an identical material for the flexible member 32 and the strength securing member 33 can avoid the problem relating to the linear expansion coefficients. More specifically, both of the flexible member 32 and the strength securing member 33 may contain silicon. In a case where both of them are formed by silicon, they are fixed by Surface Activated Bonding.

Referring to FIG. 6, the base substrate 34 is manufactured by forming the groove at the outermost part and the convex at the center as described above by performing etching processing on a plate-shaped member. Apparently from the description above, the outside dimension of the surface having the groove and convex is equal to the outside dimension of the mirror of the flexible member 32.

Then, the driving coil 35 is positioned and bonded to the base substrate 34 at the center convex. Then, the strength securing member 33 is positioned and fixed at the groove at the outermost part to the base substrate 34 to which the driving coil 35 is fixed as described above.

By fixing the components as described above, the configuration of the deformable mirror apparatus 24 as shown in FIG. 3 can be obtained.

Next, operations by the deformable mirror apparatus 24 will be described.

First of all, according to this embodiment as described above, the optical system is defined or adjusted such that the second recording layer L2 of the optical disk D can be a reference recording layer without the necessity for spherical aberration correction. Therefore, in a case where a read operation is performed on the second recording layer L2, the mirror of the deformable mirror apparatus 24 is not deformed.

More specifically, in order to perform a read operation on the second recording layer L2, the system controller 10 shown in FIG. 1 instructs the mirror driving circuit 15 to set the drive signal level to be given to the deformable mirror apparatus 15 (or the driving coil 35) to Level 0, which prevents the deformation of the mirror.

The state of the mirror of the deformable mirror apparatus 24 in this case is shown in FIG. 3.

According to this embodiment, it is important to deform the mirror when the first recording layer L1 or the third recording layer L3 is focused.

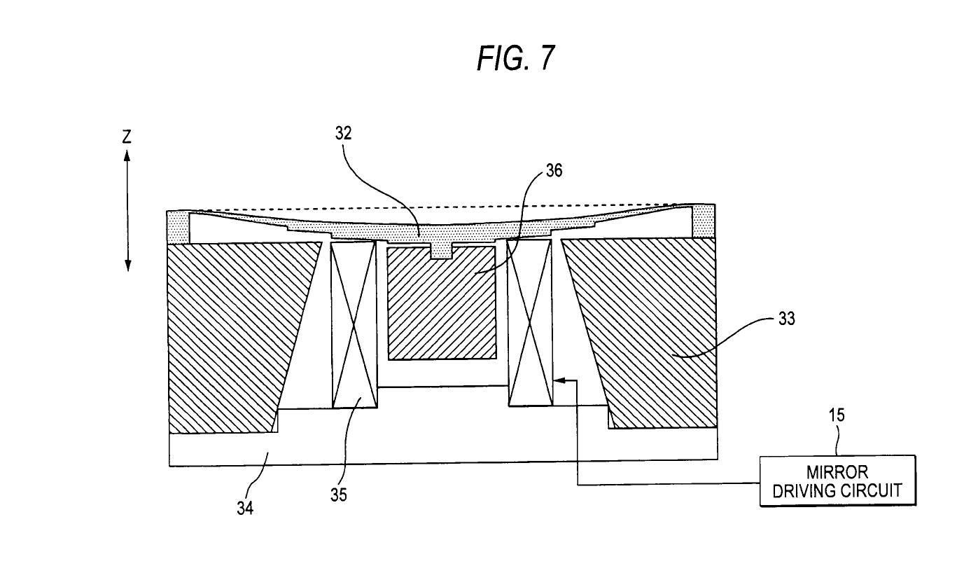

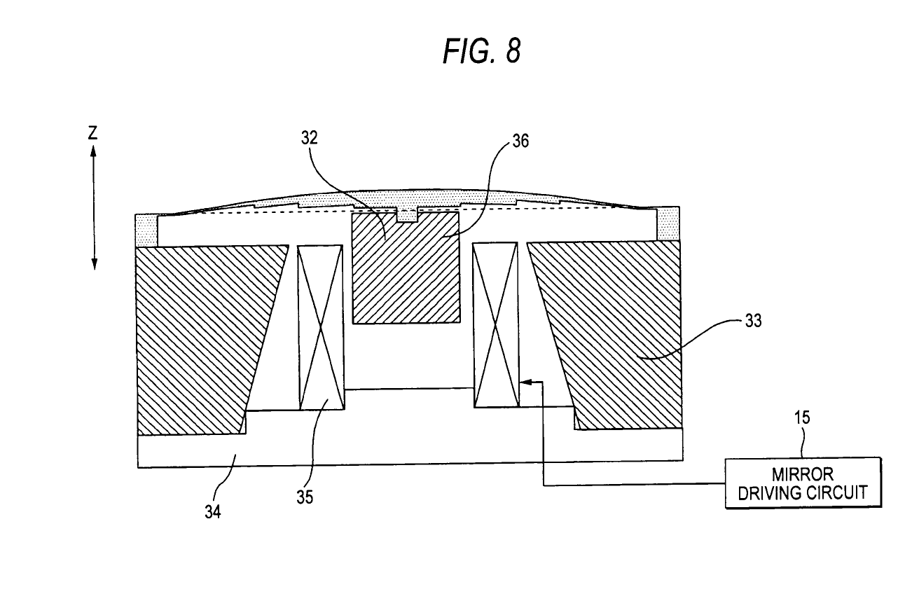

FIGS. 7 and 8 show section views of the deformable mirror apparatus 24 in a case where the mirror is deformed. For convenience of illustration, FIGS. 7 and 8 do not show the reflective film 31. For comparison, FIGS. 7 and 8 show the state of the mirror without deformation in FIG. 3 by a broken line.

First of all, in order to perform a read operation on the first recording layer L1, the system controller 10 instructs the mirror driving circuit 15 to set the level of the drive signal to be given to the driving coil 35 to a predetermined level. Thus, the drive signal at the predetermined level is supplied to the driving coil 35.

When the driving coil 35 is energized in this way, the magnetic field according to the energization level is generated, and the magnet 36 placed within the driving coil 35 receives the repulsive force from the generated magnetic field. In this case, the magnet 36 is magnetized in the axial direction of the cylinder, and the repulsive force is caused in the Z-axis direction. In other words, this causes the application of even driving force in the Z-axis direction according to the level of the drive signal to the center part of the flexible member 32 to which the magnet 36 is fixed.

In this case, the winding direction of the coil in the driving coil 35 and the polarity (South/North pole) of the magnet 36 are defined such that the magnet 36 can be displaced toward the base substrate 34 against the polarity of the drive signal supplied in response to the read operation on the first recording layer L1. Thus, in the read operation on the first recording layer L1, the form of the flexible member 32 (or the mirror) can be deformed to a concave shape as shown in FIG. 7.

At that time, the strength distribution pattern 32a with the eclipses 32A to 32E is formed on the flexible member 32. Thus, in response to the even application of the predetermined amount of pressure according to the level of the drive signal supplied to the driving coil 35 to the center part of the flexible member 32, the predetermined deformation form according to the strength distribution can be obtained. In other words, the deformation form of the flexible member 32, which is obtained according to the evenly applied pressure as described above, can be determined by the formation pattern of the strength distribution pattern 32a.

The strength distribution pattern 32a in this case is defined to obtain a form of the mirror allowing correction of the spherical aberration caused by differences in cover thickness by 0.025 mm when an even predetermined amount of driving force (pulling pressure) is applied to the center part of the flexible member 32 as described above. Thus, by controlling the corresponding deformation of the mirror in a read operation on the first recording layer L1 as described above, the spherical aberration can be corrected.

On the other hand, in a read operation on the third recording layer L3, the system controller 10 instructs the mirror driving circuit 15 to invert the polarity of the drive signal to the driving coil 35 from that of the case where a read operation is performed on the first recording layer L1.

Inverting the polarity to be supplied to the driving coil 35 from that of the case where a read operation is performed on the first recording layer L1 causes the application of even driving force (pushing force) to the opposite side of the base substrate 34 at the center part of the flexible member 32. As a result, the flexible member 32 is deformed to have a convex on the mirror side as shown in FIG. 8.

Here, as in the description above, the strength distribution pattern 32a is defined to obtain a concave-shaped deformation form of the mirror allowing correction of the spherical aberration caused upon focusing on the first recording layer L1 by giving a predetermined amount of displacement to the center part of the flexible member 32 by the application of a predetermined amount of pressure.

Accordingly, by deforming the mirror to have a convex form by giving an equal amount of displacement to the center part of the flexible member 32 in the opposite direction, the deformation form of the mirror can be obtained which allows correction of the spherical aberration caused upon focusing on the third recording layer L3, which is displaced by the same 0.025 mm in absolute amount.

Here, in order to give a predetermined amount of displacement in the opposite direction as described above, the absolute value level of the drive signal to be supplied to the driving coil 35 may be defined substantially equally to that of the case where the first recording layer L1 is focused. However, strictly speaking, it is important to consider the self-weights of the flexible member 32 and magnet 36 for changing to the direction of the convex.

Accordingly, for the change in the direction of the convex, it is desirable to adjust in advance the absolute value of the drive signal level to be supplied to the driving coil 35 such that the amount of displacement of the center part of the flexible member 32 with the application of the driving force can be the equal amount of displacement to that of the case for deformation to a concave shape. By performing such adjustment, the precision for correction of the spherical aberration can be more increased in a case where the third recording layer L3 is focused.

Apparently from the description above, the strength distribution pattern 32a formed on the flexible member 32 is an important factor for obtaining a predetermined deformation form of the mirror for spherical aberration correction. The strength distribution pattern 32a for obtaining a predetermined deformation form of the mirror for spherical aberration correction according to the application of a predetermined amount of driving force (or the amount of displacement of the center part of the flexible member 32) can be identified by using an FEM (Finite Element Method) simulation tool, for example, as disclosed in Patent Document 3.

In this way, the disk drive apparatus of this embodiment allows spherical aberration correction using the deformable mirror apparatus 24.

As shown in FIG. 3, in the deformable mirror apparatus 24 of this embodiment, the strength securing member 33 is provided between the base substrate 34 and the flexible member 32, and the flexible member 32 is supported by the strength securing member 33 from the base substrate 34 side. Thus, even in a case where stress occurs within the deformable mirror apparatus 24 when the deformable mirror apparatus 24 is attached to the drive apparatus body (or a predetermined position within the optical pickup 1), the transmission of the force based on the stress to the flexible member 32 can be effectively suppressed. In other words, the deterioration of the flatness of the mirror due to the attachment can be suppressed as a result.

The suppression of the deterioration of the flatness in this way can improve the precision for deformation of the mirror. Accordingly, the precision for aberration correction can be improved.

According to this embodiment, the width g of the strength securing member 33 is defined to be wider than the width q of the frame 32F of the flexible member 32 at least. Thus, under the assumption that the flexible member 32 and the strength securing member 33 contain a material or materials having an equal rigidity (flexural strength), the strength against the stress upon attachment can be obtained more securely than the case without the strength securing member 33 as in the past. Thus, this can suppress the deterioration of the flatness of the mirror securely.

According to this embodiment, the separately provided strength securing member 33 side is responsible for the function of securing the strength instead of the flexible member 32 side. This can effectively suppress increases in size of the apparatus for securing the strength.

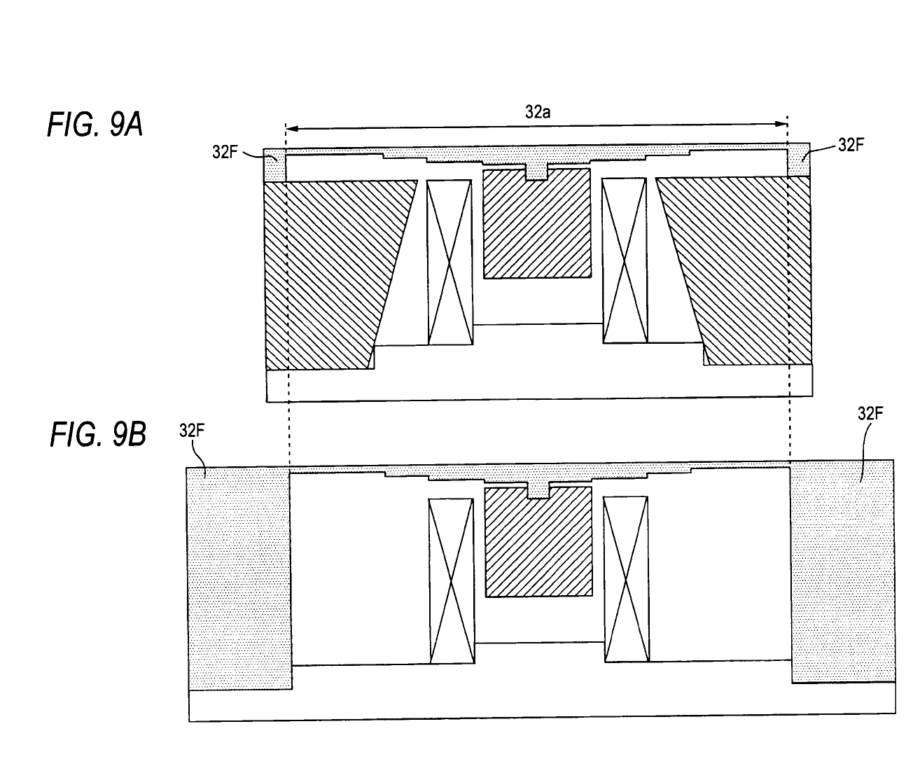

Here, if the width q of the frame 32F of the flexible member 32 is increased to secure the strength without the strength securing member 33, the horizontal section thickness of the frame F may be increased in the outer circumferential direction as shown in FIG. 9B. This is because it is important to obtain the space for the strength distribution pattern 32a to obtain a predetermined deformation form of the mirror.

On the other hand, in a case where the strength securing member 33 is provided, the strength can be secured by increasing the horizontal section thickness of the strength securing member 33 in the inner circumferential direction than the frame 32F as shown in FIG. 9A. As a result, apparently from the comparison between FIGS. 9A and 9B, the increase in size of the apparatus for securing the strength can be suppressed.

The configuration in which the separately provided strength securing member 33 is responsible for the function of securing the strength can eliminate the necessity for the increase in the vertical section thickness (height p) of the frame 32F of the flexible member 32. Thus, the etching depth for etching processing can be reduced accordingly for forming the frame 32F and strength distribution pattern 32a of the flexible member 32.

Thus, the time for the etching step can be reduced, which can improve the manufacturing efficiency and can reduce the apparatus manufacturing costs.

The reduced etching depth in this way can improve the precision for the dimensions of the step form of the strength distribution pattern 32a, which can improve the precision for aberration correction.

In order to secure the strength against the stress caused upon attachment of the apparatus, a method may be considered in which the frame section having a certain section thickness is integrated to the outer circumferential part of the base substrate 34, for example.

However, there is apprehension that the integration of the frame section for securing the strength to the base substrate 34 allows easy transmission of the stress caused at the bottom of the base substrate 34 to the frame section and thus allows easy deformation of the flexible member 32.

In a case where the base substrate 34 and the frame section for securing the strength are integrated, the base substrate 34 is formed to have a concave section form. However, in reality, it is important to form a convex at the bottom of the base substrate 34 for positioning and fixing the driving coil 35 as described above. In other words, the frame section on the outer circumferential part is an impediment to the processing of the convex for positioning in this case, which may increase the difficulty of the processing, decrease the manufacturing efficiency and therefore increase the manufacturing costs.

In a case where the strength securing member 33 is provided separately according to this embodiment on the other hand, the coil positioning part of the base substrate 34 can be formed by greatly easy processing, which can decrease the manufacturing costs accordingly. The strength securing member 33 can be manufactured by greatly easy processing of forming a hole in a predetermined diameter in the original member at least.

The deformable mirror apparatus 24 of this embodiment adopts the moving-magnet type configuration in which the magnet 36 is fixed to the flexible member 32 side (or the movable side) while the driving coil 35 is fixed to the base substrate 34 side (fixed side). This can also improve the precision for aberration correction.

It is important to connect a wiring cable for coil feeding to the movable side in the configuration that the coil is fixed to the movable side (flexible member side) as shown in FIG. 19 of Patent Document 3. However, in this configuration, pressure may be given to the flexible member due to the stress caused by bending the feeding cable, for example, and the flatness may therefore be deteriorated by the deformation of the mirror.

On the other hand, the moving-magnet type configuration of this embodiment can prevent the pressure by the feeding cable to the movable side, and the flatness can be obtained more securely. If the flatness of the mirror can be obtained at the initial state (without deformation), the precision for aberration correction can be accordingly improved.

The moving-magnet type configuration in which the driving coil 35 is fixed to the base substrate 34 side can release the generated heat in the driving coil 35 to the base substrate 34 side. In other words, by selecting a material with a higher thermal conductivity for the base substrate 34 in this case, for example, the increase in temperature within the deformable mirror apparatus 24 can be effectively suppressed.

The configuration of the deformable mirror apparatus 24 of this embodiment allows the manufacturing by using semiconductor manufacturing processes such as depositing, etching and bonding as described above with reference to FIG. 6 as the manufacturing steps. Therefore, the mass production with high precision can be easier.

The usability of semiconductor manufacturing processes can reduce the size of the deformable mirror apparatus 24, which can keep the manufacturing costs lower.

In the disk drive apparatus of this embodiment, the optical system is designed or adjusted so as to eliminate the necessity for spherical aberration correction by focusing on the middle second recording layer L2 among three recording layers of the optical disk D. Thus, the amount of spherical aberration correction upon focusing on either first recording layer L1 or third recording layer L3 may be equal to an amount of correction for one layer. If the optical system is designed or adjusted to eliminate the spherical aberration correction by focusing on the first recording layer L1 or third recording layer L3, the amount of deformation of the mirror may be the amount for two layers at maximum, which forces the increase in costs for the use of a stronger member than the flexible member 32. On the other hand, the configuration focusing on the middle second recording layer L2 as described above can reduce the strength that the flexible member 32 needs accordingly. Therefore, the number of selectable materials may increase, and the costs can be reduced.

If two recording layers are only provided, the optical system may be designed or adjusted such that the amount of spherical aberration can be zero at the middle. Thus, the amount of deformation of the mirror for correcting the spherical aberration of each layer can be the amount for half layer. Therefore, the same effect can be obtained.

### Variation Examples

Having described the embodiments of the invention, the invention is not limited to the specific examples, which have been described up to this point.

For example, the forms and dimensions of the components of the deformable mirror apparatus illustrated in the description above are only examples and can be changed as required without departing the scope of the invention.

For example, the number of eclipses to be formed in the strength distribution pattern 32a is five of the eclipses A to E but is not limited in particular.

Having only illustrated in the description up to this point the case where the drive signal at a predetermined level is supplied to the driving coil 35 to perform the spherical aberration correction corresponding to the difference in cover thickness for one layer, the spherical aberration correction corresponding to the difference in cover thickness for two or more layers can be performed. In this case, as described in Patent Document 3, the pressure to be applied to the flexible member 32 can be changed in a stepwise manner by changing the level of the drive signal to be supplied to the driving coil 35. The strength distribution pattern 32a may be formed so as to obtain predetermined deformation patterns in a stepwise manner according to the driving force levels, which vary in a stepwise manner.

Having illustrated the case where the driving coil 35 is fixed to the base substrate 34 in the description up to this point, the driving coil 35 may be fixed to the strength securing member 33. In other words, the driving coil 35 may be fixed at least to the fixed side excluding the flexible member 32 in the moving-magnet configuration.

Alternatively, instead of the moving-magnet type configuration, the configuration can be adopted in which the magnet 36 and the driving coil 35 are fixed to the fixed side and the movable side, respectively.

Having illustrated the configuration in which the driving means gives the pressure based on electromagnetic force to the flexible member in the description up to this point, the driving means may have other configuration such as a configuration in which the upper electrode and the lower electrode are provided on the opposite surface of the mirror and the fixed side such as the base substrate, respectively and the flexible member is driven to deform by using the electrostatic force caused by the energization of the electrodes.

Having illustrated the case where the forms of the eclipses are axially symmetrical both in the X-axis direction and the Y-axis direction as shown in FIG. 4A, the forms may not be axially symmetrical in the X-axis direction for preventing the displacement of the reflection angle of reflected light as described in Patent Document 3.

For the purpose of improvement of the flatness of the flexible member 32 after forming the reflective film 31, a reflective film containing the same material may be also formed on the opposite side of the mirror of the reflective member 32.

Having illustrated the case where the deformable mirror apparatus 24 is placed as a 45-degree mirror and the optical axis of incident light is changed by 90 degrees on the mirror, the deformable mirror apparatus 24 may be provided to change the laser optical axis by 180 degrees.

In this case however, since the spot of laser light on the mirror is circular, the strength distribution form is formed to be circular (refer to Patent Document 3 for this point).

The configuration for the reflection by 180 degrees may be limited in that the laser light can be irradiated to the optical disk D by linear polarization only as described in Patent Document 3. Laser light is desirably irradiated to the optical disk D by circular polarization in order to reduce the influence of the variations in characteristics among optical disks D on the optical system, for example, generally in designing the optical system. In consideration of the use efficiency of the laser light from emitted from the laser diode LD to detected by the photodetector 28 in addition, the return light from the optical disk D is desirably returned to the detector 28 by linear polarization.

Apparently from the description above, the configuration of the optical system having the deformable mirror apparatus 24 as a 45-degree mirror can irradiate laser light to the optical disk D by circular polarization and can guide the return light from the optical disk D to the detector 28 by linear polarization. Thus, with the configuration with a 45-degree mirror, the influence of the variations in characteristics of the optical disk D can be reduced, and the use efficiency of light can be improved.

The strength distribution pattern may partially cut out, for example, instead of the formation all around the eclipses as illustrated according to the embodiment.

The strength distribution pattern is not limited to an oval (or circular) pattern but may have any form if a predetermined deformation form of the flexible member can be obtained according to the application of necessary driving force.

Having illustrated the case where the optical drive apparatus of the embodiment of the invention is a drive apparatus supporting a high recording density disk such as a BD in the description above, the invention is suitably applicable to a drive apparatus supporting other optical disks each having multiple recording layer.

The invention is also suitably applicable to a drive apparatus that supports an optical disk having a single recording layer and performs spherical aberration correction according to the change in cover thickness within one track, for example.

The optical drive apparatus of the embodiment of the invention can have not only the configuration supporting the optical disks above but also the configuration supporting an optical recording medium having other shapes such as a rectangular shape excluding a disk shape. The term “optical recording medium” here refers to a recording medium to/from which information is written/read by irradiation of light.

Having illustrated the case where the deformable mirror apparatus of the embodiment of the invention is applied to an optical drive apparatus that writes or reads to or from an optical recording medium in the description above, the deformable mirror apparatus is suitably applicable to other apparatus such as an optical system of a camera apparatus. Also in this case, the configuration of the deformable mirror apparatus of the embodiment of the invention can effectively suppress the deterioration of the flatness of the mirror due to the stress caused upon attachment to another apparatus.

It should be understood by those skilled in the art that various modifications, combinations, sub-combinations and alterations may occur depending on design requirements and other factors insofar as they are within the scope of the appended claims or the equivalents thereof.

What is claimed is:

1. A deformable mirror apparatus comprising:
a flexible member having a mirror on a surface and having a part having a different section form to form a convex on the opposite surface of the mirror such that a predetermined strength distribution is imparted to the flexible member;
a base substrate;
a strength securing member provided between the base substrate and the flexible member to support the flexible member from the base substrate side; and
a driving section that deforms the form of the mirror by applying driving force to the opposite surface of the mirror of the flexible member.

2. The deformable mirror apparatus according to claim 1, wherein the flexible member has a section form in which the vertical section of the outermost part is the thickest and the thickness of the vertical section decreases in a stepwise manner from the center of the mirror toward the outer circumferential direction.

3. The deformable mirror apparatus according to claim 1, wherein the driving section is configured to deform the mirror by applying pressure based on electromagnetic force to the opposite surface of the mirror of the flexible member.

4. The deformable mirror apparatus according to claim 3, the driving section having:
a magnet fixed to the opposite surface of the mirror of the flexible member and a coil fixed to the base substrate or the strength securing member,
wherein the mirror is deformed by applying pushing pressure or pulling pressure to the flexible member by energizing the coil.

5. The deformable mirror apparatus according to claim 1, wherein the apparatus is placed to reflect incident light by 90 degrees, and the parts having different section forms have oval forms having an identical center.

6. The deformable mirror apparatus according to claim 1, wherein the flexible member contains silicon, and the strength securing member contains Pyrex glass, and the flexible member and the strength securing member are fixed by anodic bonding.

7. The deformable mirror apparatus according to claim 1, wherein the flexible member and the strength securing member both contain silicon, and the flexible member and the strength securing member are fixed by surface activated bonding.

8. The deformable mirror apparatus according to claim 1, wherein the strength securing member has a hole at the center, and the thickness of the horizontal section of the outer circumferential wall around the hole is thicker than the thickness of the horizontal surface of the outermost part of the flexible member at least.

9. An optical pickup comprising:
an optical system that outputs light emitted from a light source through an objective lens; and
a deformable mirror apparatus in which the mirror can be deformed about a predetermined position of the optical system,
wherein the deformable mirror apparatus has
a flexible member having a mirror on a surface and having a part having a different section form to form a convex on the opposite surface of the mirror such that a predetermined strength distribution is imparted to the flexible member,
a base substrate,
a strength securing member provided between the base substrate and the flexible member to support the flexible member from the base substrate side, and
a driving section that deforms the form of the mirror by applying driving force to the opposite surface of the mirror of the flexible member.

10. An optical drive apparatus that writes to or reads from an optical recording medium to/from which information is written/read by the irradiation of light, the apparatus comprising:
an optical pickup having
an optical system that outputs light emitted from a light source through an objective lens, and
a deformable mirror apparatus in which the mirror can be deformed about a predetermined position of the optical system,
the deformable mirror apparatus having
a flexible member having a mirror on a surface and having a part having a different section form to form a convex on the opposite surface of the mirror such that a predetermined strength distribution is imparted to the flexible member,
a base substrate,
a strength securing member provided between the base substrate and the flexible member to support the flexible member from the base substrate side, and
a driving section that deforms the form of the mirror by applying driving force to the opposite surface of the mirror of the flexible member, and
a control section that controls the deformation of the mirror by controlling the driving section in the deformable mirror apparatus.
